(19) United States
(12) Patent Application Publication
(10) Pub. No.: US 2024/0312268 A1
(43) Pub. Date: Sep. 19, 2024

(54) METHODS AND APPARATUS FOR UTILIZING A HUMAN MACHINE INTERFACE OF AN AUTONOMOUS VEHICLE

(71) Applicant: Nuro, Inc., Mountain View, CA (US)

(72) Inventors: Emily Anna Weslosky, Menlo Park, CA (US); Brandon Buckley, San Francisco, CA (US); Samantha Ho, Mountain View, CA (US); Marcus Johann Strom, Phoenix, AZ (US)

(73) Assignee: Nuro, Inc., Mountain View, CA (US)

(21) Appl. No.: 18/593,801

(22) Filed: Mar. 1, 2024

Related U.S. Application Data
(60) Provisional application No. 63/490,346, filed on Mar. 15, 2023.

(51) Int. Cl. G07C 5/08; G06F 21/31; G06F 21/44

(52) U.S. Cl. CPC G07C 5/0825; G06F 21/31; G06F 21/44; G07C 5/0808; G06F 2221/2141

(57) ABSTRACT

According to one aspect, a method includes determining when a vehicle is in a location that is suitable for providing status information on a human machine interface (HMI). The vehicle includes an autonomy system, a diagnostics system, a mode module, and the HMI which is arranged to provide a user interface. The method also includes determining the status information for the vehicle using the diagnostics system when it is determined that the vehicle is in the location that is suitable for providing the status information, and setting the HMI to a first mode using the mode module when it is determined that the vehicle is located in the location that is suitable for providing the status information. The status information is provided to the mode module after setting the HMI to the first mode. Finally, the method includes providing the status information to the HMI to be displayed.

### PRIORITY CLAIM

This patent application claims the benefit of priority under 35 U.S.C. § 119 to U.S. Provisional Patent Application No. 63/490,346, filed Mar. 15, 2023, and entitled “METHODS AND APPARATUS FOR UTILIZING A HUMAN MACHINE INTERFACE OF AN AUTONOMOUS VEHICLE,” which is incorporated herein by reference in its entirety.

### TECHNICAL FIELD

The disclosure relates to providing systems for use with autonomous vehicles. More particularly, the disclosure relates to systems which enable fleets of autonomous vehicles to be managed efficiently.

### BACKGROUND

The handling and delivery of goods and services using autonomous vehicles will improve society, e.g., by allowing people to engage in productive work while waiting for an autonomous vehicle to deliver goods rather than spending time procuring the goods. As the use of autonomous vehicles is growing, the ability to operate the autonomous vehicles efficiently and safely, and to manage the safe deployment of a fleet of autonomous vehicles, is becoming more important.

To enable autonomous vehicles to be operated both efficiently and safely, maintenance may be performed on the autonomous vehicles as needed, e.g., when an issue is identified, and/or at regular intervals. To properly perform maintenance on a vehicle, a technician may need information regarding what types of maintenance the vehicle may need. Often, a technician may plug a computing device into a vehicle to obtain status information associated with the vehicle. The use of an external device to obtain information from a vehicle such that a technician may determine which actions are to be taken is often cumbersome and, thus, inefficient.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic representation of a vehicle which is located outside of a first location in accordance with an embodiment,

FIG. 4B is a diagrammatic representation of a vehicle, e.g., vehicle 401 of FIG. 4A, which is located inside of or within a first location in accordance with an embodiment.

FIG. 4C is a diagrammatic representation of a vehicle, e.g., vehicle 401 of FIGS. 4A and 4B, which includes an input/output interface which may cause a human machine interface (HMI) to trigger a depot mode when a user is authenticated to access information displayed on the HMI when the HMI is in depot mode in accordance with an embodiment.

FIG. 5A is a process flow diagram which illustrates a first method of providing status information on an HMI of a vehicle in accordance with an embodiment.

FIG. 5B is a process flow diagram which illustrates a second method of providing status information on an HMI of a vehicle in accordance with an embodiment.

FIG. 6 is a process flow diagram which illustrates a method of performing maintenance on a vehicle with an HMI that display status information in accordance with an embodiment.

FIG. 7 is a block diagram representation of an overall system which is configured to provide status information and to enable a mode to be selected with respect to an HMI on a vehicle in accordance with an embodiment.

FIG. 8A is a diagrammatic representation of a vehicle located in a depot zone of an overall environment in accordance with an embodiment.

FIG. 8B is a diagrammatic representation of a vehicle located in an intermediate zone of an overall environment, e.g., vehicle 801 and overall environment 868 of FIG. 8A, in accordance with an embodiment.

FIG. 8C is a diagrammatic representation of a vehicle located in a destination zone of an overall environment, e.g., vehicle 801 and overall environment 868 of FIG. 8A, in accordance with an embodiment.

FIG. 9 is a process flow diagram which illustrates a method of using an HMI of a vehicle set in a depot mode to achieve a “mission ready” status for the vehicle in accordance with an embodiment.

FIG. 10 is a diagrammatic representation of a timeline associated with obtaining and providing status information associated with a vehicle when the vehicle enters into a depot zone in accordance with an embodiment.

FIG. 11 is a diagrammatic representation of a timeline associated with obtaining and providing status information associated with a vehicle when the vehicle detects an interaction which indicates depot zone is activated in accordance with an embodiment.

FIG. 12 is a diagrammatic representation of interactions based on an HMI mode in accordance with an embodiment.

### DESCRIPTION OF EXAMPLE EMBODIMENTS

### General Overview

In one embodiment, a method includes determining when a vehicle is in a location that is suitable for providing status information associated with the vehicle on a human machine interface (HMI) of the vehicle, the vehicle including an autonomy system arranged to enable the vehicle to operate autonomously, a diagnostics system, a mode module, and the HMI, the HMI being arranged to provide a user interface which allows interactions with the vehicle. The method also includes determining the status information for the vehicle using the diagnostics system when it is determined that the vehicle is in the location that is suitable for providing the status information associated with the vehicle on the HMI, and setting the HMI to a first mode using the mode module when it is determined that the vehicle is located in the location that is suitable for providing the status information associated with the vehicle on the HMI. The status information is caused to be provided to the mode module after determining the status information and setting the HMI to the first mode. Finally, the method includes providing the status information to the HMI, wherein the HMI is further arranged to display the status information.

According to another embodiment, logic encoded in one or more tangible non-transitory, computer-readable media for execution is operable, when executed, to provide an autonomy system on a vehicle, provide a diagnostics system on the vehicle, provide an HMI on the vehicle, and enable a mode selection for the HMI. The logic is also operable to determine when the vehicle is in a location that is suitable for providing status information associated with the vehicle on the HMI, and to determine the status information for the vehicle using the diagnostics system when it is determined that the vehicle is in the location that is suitable for providing the status information associated with the vehicle on the HMI. When it is determined that the vehicle is located in the location that is suitable for providing the status information, the logic is operable to set the HMI to a first mode using the mode module, to cause the status information to be provided to the mode module after the status information is determined and after the HMI is set to the first mode, and to provide the status information to the HMI, wherein the HMI is further arranged to display the status information.

In accordance with still another embodiment, a vehicle includes an autonomy system, a diagnostics system, and a first input/output arrangement. The autonomy system is arranged to enable the vehicle to operate autonomously, and includes a set of sensors. The diagnostics system is configured to obtain status information associated with the vehicle from at least the set of sensors. The first input/output arrangement includes a mode module and an HMI. The HMI is arranged to provide a user interface which allows interactions with the vehicle when set in a second mode by the mode module. The first input/output arrangement is arranged to obtain the status information from the diagnostics system, wherein the mode module is arranged to identify a location of the vehicle using the set of sensors and to determine when the location is suitable to enable the status information to be accessed through the HMI. When the mode module determines that the location is suitable to enable the status information to be accessed through the HMI, the mode module sets a first mode for the HMI and provides the status information to the HMI.

When an autonomous vehicle identifies an issue associated with the autonomous vehicle, the autonomous vehicle may effectively surface the issue by causing an indicator of the issue to be displayed on an HMI of the autonomous vehicle when the autonomous vehicle is at a location at which maintenance is to be performed, e.g., when the vehicle is at a depot or a garage. When the vehicle is deployed for pick up and/or delivery purposes, the HMI may be configured to provide a screen which allows a user to interact with the vehicle to load an item into the vehicle and/or to remove an item from the vehicle. Once the vehicle is located at a maintenance or other secure location, the HMI may be configured to provide a user with information relating to the status of the vehicle or, more specifically, the status of various systems on the vehicle. In some situations, the HMI may provide a user with information relating to the status of the vehicle upon the user being successfully authenticated.

### Description

As the use of autonomous vehicles becomes more widespread, the ability to efficiently address issues with the autonomous vehicles is increasing in importance. For example, when an autonomous vehicle has an operational issue or may otherwise need maintenance, the ability to promptly provide information regarding the operational issue or the type of maintenance needed to a party tasked with resolving the issue or performing the maintenance is critical to enable the task or maintenance to be performed efficiently. When tasks that essentially need to be performed on a particular vehicle in a fleet of vehicles may be readily identified, the amount of downtime for the vehicle may be reduced. Because an autonomous vehicle generally does not have a driver onboard who may be able to identify maintenance issues, the ability for the autonomous vehicle itself to provide an indication of maintenance issues which may need to be addressed may greatly reduce the amount of time it may otherwise take to identity such issues.

The relatively quick and accurate identification of operational issues associated with a vehicle enables the operational issues to be addressed appropriately and in a timely fashion. As a result, any downtime associated with an autonomous vehicle which encounters an operational issue, as well as downtime associated with maintenance, may be substantially minimized. The overall scheduling and utilization of vehicles included in a fleet may be enhanced. The fleet of vehicles may, therefore, be dispatched to complete jobs or tasks, as well as to provide services, in an efficient manner.

Each vehicle included in a fleet of autonomous vehicles may be configured to identify tasks, e.g., operational issues and/or maintenance issues, and to provide those tasks to a human machine interface (HMI) mounted on or in the vehicle. When tasks are displayed on an HMI attached or otherwise coupled to a vehicle, a party responsible for ensuring that the tasks are performed may be able to readily identify the tasks to be performed. The HMI on a vehicle is generally used to provide a user such as a customer with the ability to interact with the vehicle, e.g., to provide a code that enables a compartment on the vehicle to be opened, and may include a display screen and/or a touch screen. Such an HMI may effectively be configurable to support multiple modes including, but not limited to including, a first mode which allows a user to interact with the vehicle and a second mode which allows status information associated with the vehicle to be displayed.

In one embodiment, tasks may be displayed on an HMI of a vehicle when the vehicle is at a particular location, as for example a depot or other location at which vehicle maintenance is performed, and/or when authentication information is provided, e.g., to the vehicle on which the HMI is mounted by a technician. In such an embodiment, in order to access the tasks, or to otherwise cause the tasks to be displayed on the HMI, a technician may complete an authentication process which, when completed successfully, enables the HMI to display the tasks. It should be appreciated that when a technician does not successfully complete an authentication process, the HMI may be substantially prevented from displaying tasks.

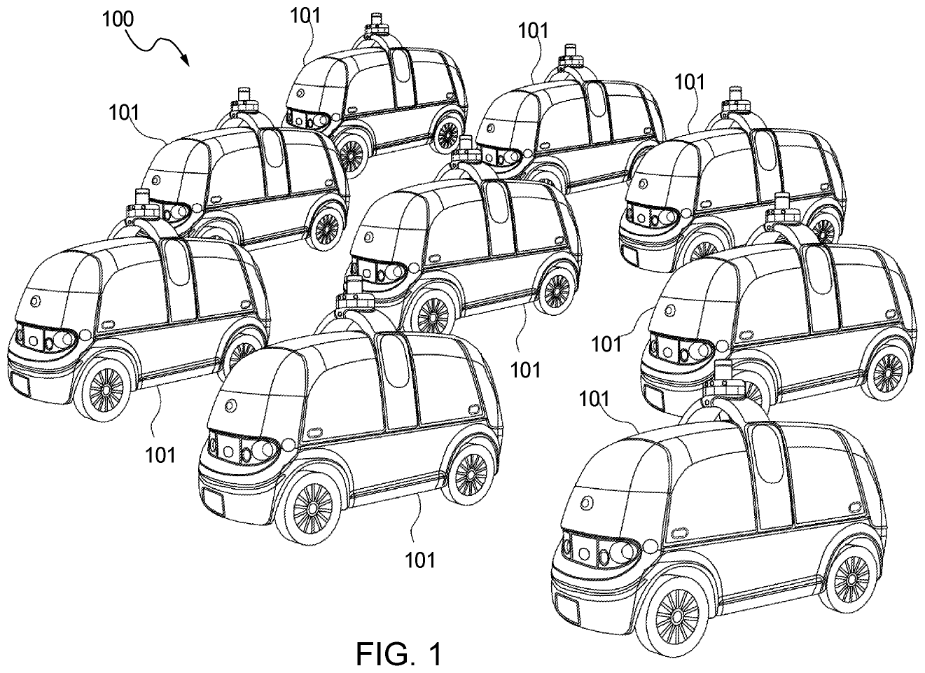

Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. In one embodiment, autonomous vehicles 101 may include vehicles which are arranged to carry passengers in addition to, or in lieu of, cargo. That is, autonomous vehicles 101 are not limited to vehicles which are configured to transport and/or to deliver cargo. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment. In one embodiment, the fleet management module may additionally, or alternatively, dispatch autonomous vehicles 101 for purposes of transporting passengers in an unstructured open environment or a closed environment.

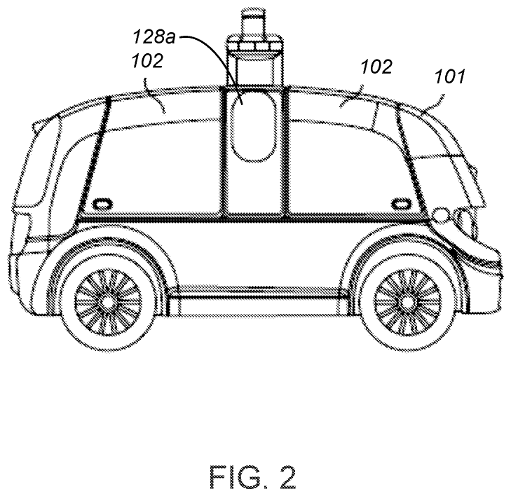

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

An input/output interface that includes an HMI 128a is arranged on an exterior of autonomous vehicle 101. HMI 128a, as shown, includes a touch screen which is arranged to display a graphical user interface (GUI) that allows a user to interact with autonomous vehicle 101. Through using HMI 128a, a user may be authenticated and/or may be granted access to the contents of compartments 102. In one embodiment, HMI 128a may be configured to display information associated with autonomous vehicle 101 such as tasks which are to be addressed. Such information may be displayed on, or otherwise be accessible using, HMI 128a when autonomous vehicle 101 is at a particular geographic location, e.g., a vehicle depot.

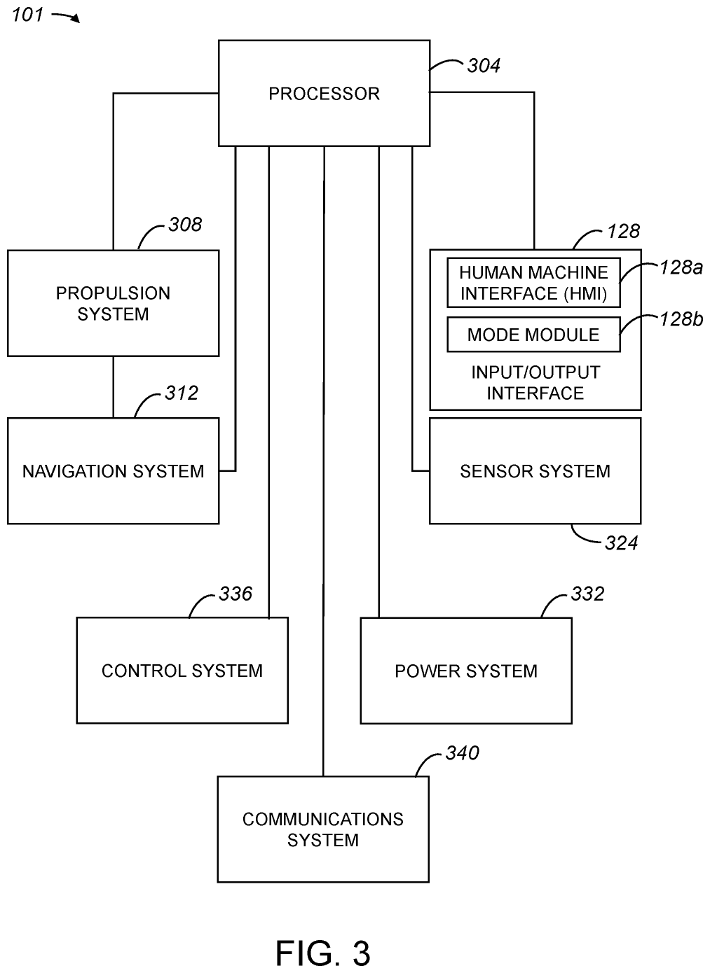

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, communications system 340, and input/output interface 128 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101. In one embodiment, sensor system 324 includes sensors which may cooperate to obtain status information associated with vehicle 101. For example, sensors of sensor system 324 may include sensors arranged to measure variables including, but not limited to including, temperatures, pressures, etc. onboard vehicle 101, and to determine when the measured values are inconsistent with the standard or “normal” values.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

Input/output interface 128 is generally arranged to enable a user to interact with autonomous vehicle 101, an includes an HMI 128a and a mode module 128b. HMI 128a, which is on an exterior of autonomous vehicle 101 as shown in FIG. 2, is configured to accept inputs from a user. As previously mentioned, HMI 128a generally includes a display screen that enables a user to provide information to autonomous vehicle 101 and also enables information to be displayed to the user. Mode module 128b includes hardware and/or software that enables HMI 128a to be configured in a particular mode. In one embodiment, the modes may include an operational mode and a depot mode. The operational mode is a mode which enables a user such as a customer to interact with autonomous vehicle 101 using HMI 128a, as for example to gain access contents of compartments 102 of FIG. 2. The depot mode is a mode which enables information such as status information, information relating to issues associated with autonomous vehicle 101, and/or tasks which are to be performed on autonomous vehicle 101 to be displayed when autonomous vehicle is at a particular location, e.g., a secure location such as a depot or a garage.

In one embodiment, mode module 128b may be configured to cause HMI 128a to enter into a particular mode based on a geographical location of vehicle 101. By way of example, when autonomous vehicle 101 is detected as being located at a depot or a garage, mode module 128b may cause HMI 128a to substantially automatically enter into depot mode. When autonomous vehicle 101 is detected as being at a delivery or pickup location, mode module 128b may cause HMI 128a to substantially automatically enter into operational mode. It should be appreciated that in some situations, mode module 128b may effectively cause HMI 128a to be in operational mode unless autonomous vehicle 101 is detected at a depot or a garage. However, in some instances, mode module 128b may have multiple modes including a mode which HMI 128a is in unless autonomous vehicle 101 is at a location suitable for depot mode and/or a location suitable for operational mode. One mode that may be suitable while autonomous vehicle 101 is driving, for example, may prevent HMI 128a from displaying a GUI or otherwise enabling interactions with HMI 128a for safety reasons. For example, while autonomous vehicle 101 is driving, HMI 128a may be in a state which displays a substantially static screen such as a screen that displays a logo and is not arranged to allow interactions.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived. Using information relating to the perceived environment, planner capabilities may be used to identify a suitable route to be travelled by autonomous vehicle 101 when autonomous vehicle 101 operates under the control of an autonomy system.

The mode in which an HMI on a vehicle operates may vary based on a location of the vehicle. In one embodiment, if the vehicle is not at, or within, one or more particular locations, the HMI on the vehicle is arranged to enable a user such as a delivery customer to use the HMI to communicate with the vehicle and/or to command the vehicle to take actions including, but not limited to including, opening, and closing compartment doors. In such an embodiment, if the vehicle is at or within the one or more particular locations, the HMI on the vehicle is arranged to operate in a mode, e.g., a depot mode, which enables status information of the vehicle to be displayed on a display screen of the HMI.

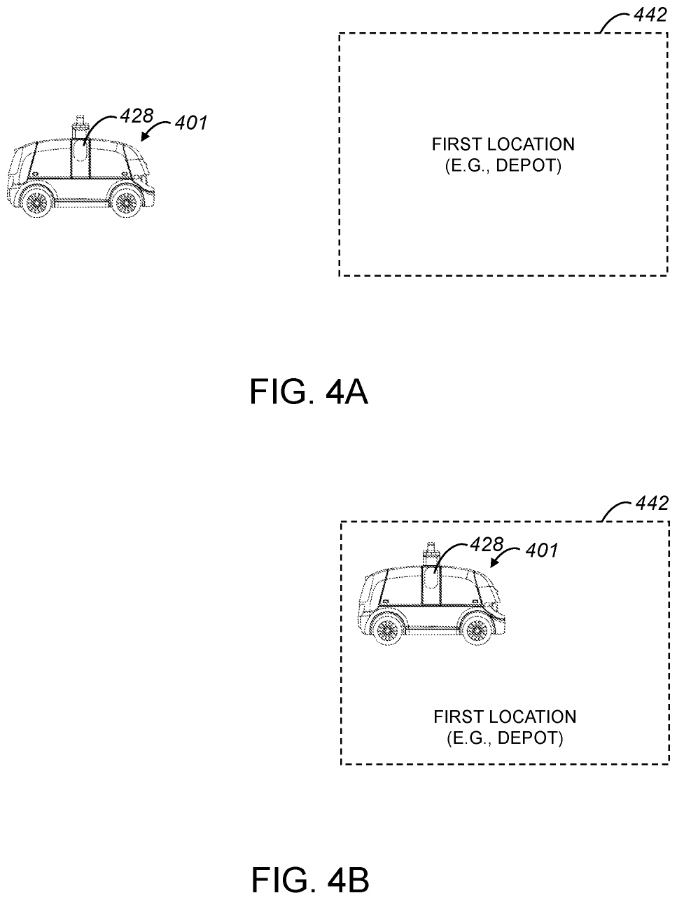

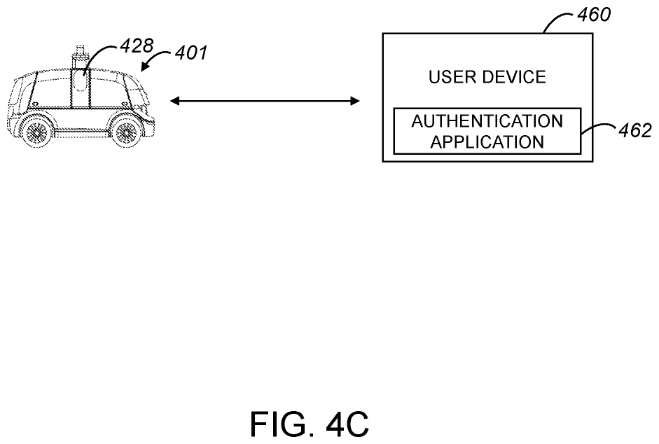

FIG. 4A is a diagrammatic representation of a vehicle which is located outside of a first location in accordance with an embodiment, A vehicle 401, which includes an input/output interface 428 that includes an HMI, is positioned outside of a defined location 442 at a time t1. Location 442 may be a depot, or other location at which information relating to the status of vehicle 401 may be displayed using input/output interface 428. In general, location 442 may be a geofenced geographical area within which the status of vehicle may be substantially automatically displayed using input/output interface 428. While vehicle 401 is not at or within location 442, input/output interface 428 may generally be used for purposes of enabling a customer to interact with vehicle 401 and/or to interact with a fleet manager associated with a vehicle fleet that includes vehicle 401. In other words, an HMI of input/output interface 428 may typically be used to support deliveries and/or pickups performed using vehicle 401.

When vehicle 401 is present at location 442, as shown in FIG. 4B, an HMI of input/output interface 428 may enter a depot mode in which status information may either be substantially automatically displayed on the HMI or displayed on the HMI after a party, e.g., a maintenance technician, enters authentication information using the HMI. In one embodiment, a mode module of input/output interface 428 may determine when vehicle 401 has entered location 442 using information collected by sensors on vehicle 401, and may substantially automatically cause the HMI of input/output interface 428 to effectively enter depot mode. Similarly, a mode module of input/output interface 428 may determine when vehicle 401 has exited location 442 using information collected by sensors on vehicle 401, and may substantially automatically cause the HMI of input/output interface 428 to effectively enter a default mode or a mode that enables the HMI to support uses of vehicle 401 such as deliveries and/or pickups.

In one embodiment, substantially regardless of where vehicle 401 is located, the HMI of input/output interface 428 may be configured in depot mode upon an authentication process being successfully completed. Such an authentication process may include, but is not limited to including, a user such as a maintenance technician having access to an authentication application and using that authentication application to access depot mode the HMI of input/output interface 428. An authentication application may enable the user to interact with the authentication access on a handheld device, and then holding the handheld device in proximity to the HMI of input/output interface 428 to enable the HMI to effectively trigger depot mode.

FIG. 4C is a diagrammatic representation of a vehicle, e.g., vehicle 401 of FIGS. 4A and 4B, which includes an input/output interface which may cause an HMI to trigger a depot mode when a user is authenticated to access information displayed on the HMI when the HMI is in depot mode in accordance with an embodiment. When a user device 460 with an authentication application 462 is used by a user to authenticate the user, the user may place user device 460 in proximity to the HMI of input/output interface 420 such that communications, e.g., near-field communications (NFC) or Bluetooth communications, may be used to enable authenticating information on user device 362 may effectively be provided to vehicle 401. In one embodiment, user device 460 may be a cellular phone or a tablet though which a user may provide credentials to authentication application 462. It should be appreciated that authentication application 462 may be included in an overall fleet management application that the user may use to facilitate the management of a fleet that includes vehicle 401.

When an HMI of an input/output interface of an autonomous vehicle is in depot mode, in addition to providing status information associated with the vehicle, the HMI may also provide functionality which enables a user to control functions on the vehicle. For example, the HMI may enable compartment doors of the vehicle to be opened and closed, enable headlights of the vehicle to be turned on and turned off, enable the vehicle to be started, enable the power state of the vehicle to be changed, enable the vehicle to be placed into a tether mode such that data may be offloaded from the vehicle and/or software on the vehicle may be updated, and enable other systems of the vehicle to be turned on and turned off.

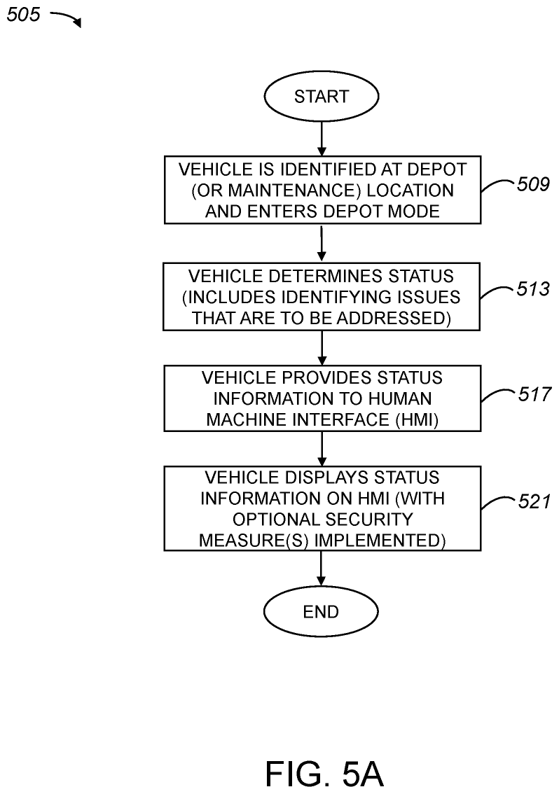

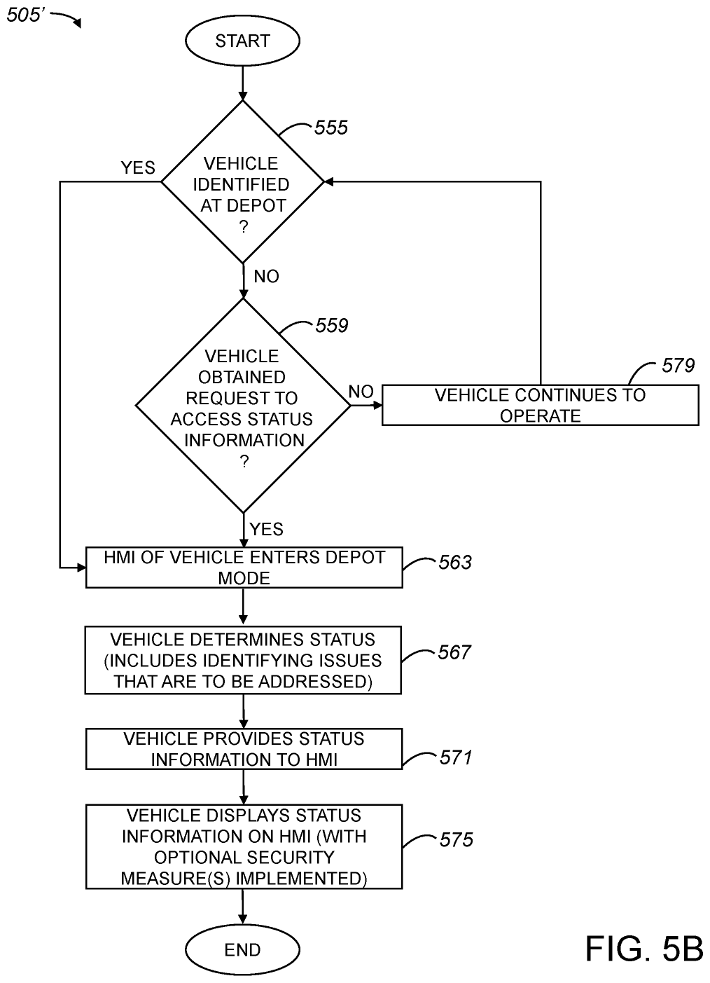

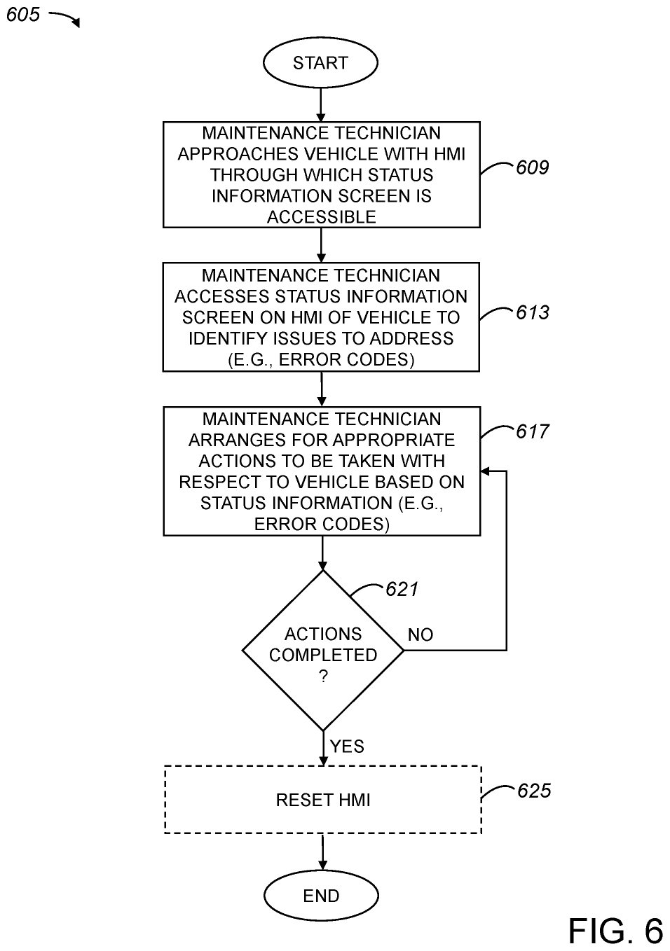

Referring next to FIG. 5A, a first method of providing status information on an HMI of a vehicle, as for example when the vehicle is at a depot or maintenance location, will be described in accordance with an embodiment. A method 505 of providing status information on an HMI of a vehicle begins at a step 509 in which the vehicle is identified as being present at a depot location, and enters into depot mode. Entering into depot mode may occur substantially automatically when the vehicle is present at the depot location, or depot mode may occur after the HMI of the vehicle is used to obtain information from a technician at the depot that is arranged to indicate that the vehicle is present at the depot. In one embodiment, information obtained from a technician that is arranged to indicate that the vehicle is present at the depot may be compared to the actual location of the vehicle, and the HMI may enter depot mode substantially only when the information provided by the technician is consistent with the actual location of the vehicle.

Once the vehicle is identified as being at the depot, the vehicle determines its status in a step 513. Status information may include, but is not limited to including, a current state of the vehicle, a distance travelled by the vehicle since the vehicle was last charged or refueled, a total distance travelled by the vehicle in its lifetime, a charge or fuel level of the vehicle, issues that may need to be addressed, air pressure levels of the tires of the vehicle, statuses of sensors, levels of fluids such as coolants and cleaning fluids, etc. The issues that may need to be addressed may be self-diagnosed by the vehicle based at least in part on measurements made by sensors on the vehicle. The status information may be stored locally on the vehicle, and/or the status information may be stored externally and may effectively be downloaded to the vehicle when the vehicle is identified as being at the depot.

After the vehicle determines its status, the vehicle provides the status information to the HMI in a step 517. Then in a step 521, the status information is displayed on the HMI. The vehicle effectively causes the status information to be displayed on a display screen of the HMI such that a technician may view the display screen to essentially ascertain the current status of the vehicle. In one embodiment, security measures may be implemented to prevent unauthorized parties from viewing the status information. For example, a technician may enter a password or otherwise be authenticated using the HMI before the status information is displayed on the HMI. Upon the vehicle displaying status information on the HMI, the method of providing status information on an HMI of a vehicle is completed.

In one embodiment, an HMI of a vehicle may enter into or otherwise be configured in depot mode either when the vehicle and, hence, the HMI is located at a depot or when a user provides an indication that the HMI is to be entered into a depot mode when the vehicle is not at a depot. Such a user may be a maintenance technician who is expected to provide emergency maintenance on a vehicle when the vehicle is not at a depot or maintenance location. When a vehicle is not at a depot or maintenance location, a user may use the HMI of the vehicle to authenticate himself or herself, and to effectively command the HMI to enter into depot mode. It should be appreciated that in lieu of using the HMI of a vehicle to authenticate himself or herself, a user may instead use a separate device such as a smart phone for authentication purposes, and the separate device may initiate communications with the HMI to cause the HMI to enter into depot mode upon successful completion of an authentication process. In one embodiment, the separate device may communicate with the HMI using near field communications (NFC).

FIG. 5B is a process flow diagram which illustrates a second method of providing status information on an HMI of a vehicle in response to the vehicle either being at a depot or a user essentially requesting that the vehicle provide status information in accordance with an embodiment. A method 505′ of providing status information on an HMI of a vehicle begins at a step 555 in which a determination is made as to whether the vehicle has been identified as being located at a depot or maintenance location. If the determination is that the vehicle is not located at a depot, process flow moves to a step 559 in which it is determined whether the vehicle has obtained a request to access status information. In one embodiment, such a determination may be obtained by the vehicle through the interaction of a user with the HMI of the vehicle.

If it is determined in step 559 that the vehicle has not obtained a request to access status information, the vehicle continues to operate in a step 579. From step 579, process flow returns to step 555 in which it is determined whether the vehicle is identified as being located at a depot.

Alternatively, if it is determined in step 559 that the vehicle has obtained a request to access status information, the HMI of the vehicle enters into depot mode in step 563. After the HMI enters into depot mode, the vehicle identified as being at the depot, the vehicle determines its status in a step 567.

Once the vehicle determines its status, the vehicle provides the status information to the HMI in a step 571. Providing the status information may include the vehicle obtaining the status information from a data storage arrangement on the vehicle and providing the status information to the HMI, and/or the vehicle obtaining the status information from a data storage arrangement that is not on the vehicle and providing the status information to the HMI.

The status information is displayed on the HMI in a step 575. The vehicle effectively causes the status information to be displayed on a display screen of the HMI such that a technician may view the display screen to essentially ascertain the current status of the vehicle, and to identify issues which are to be mitigated. It should be appreciated that optional security measures may be implemented to substantially prevent unauthorized parties from gaining access to the status information. The method of providing status information on an HMI of a vehicle is completed once the vehicle displays the status information.

Returning to step 555, if it is determined that the vehicle is identified at a depot, process flow moves to step 563 in which the HMI of the vehicle enters into depot mode. In the described embodiment, when the vehicle is located at the depot, the HMI of the vehicle substantially automatically enters into depot mode. It should be appreciated, however, that in some embodiments, the HMI of the vehicle may not substantially automatically enter into depot mode once the vehicle is detected at a depot or specific geofenced location, e.g., a user such as a technician may engage in an authentication process before the HMI enters into depot mode.

The display of status information on an HMI of a vehicle facilitates the performance of maintenance, and enhances the ability to address issues on the vehicle. The status information is readily available, as the status information is effectively displayed on the vehicle to which the status information applies. As discussed above with respect to FIG. 5, in one embodiment, an HMI on a vehicle may effectively enter into depot mode substantially upon the arrival of the vehicle at a secure location such as a depot. Alternatively, an HMI may be put into depot mode upon a user, e.g., a maintenance technician or other individual with access rights to the status information associated with a vehicle, successfully completing an authentication process.

FIG. 6 is a process flow diagram which illustrates a method of performing maintenance on a vehicle with an HMI that display status information in accordance with an embodiment. A method 605 of performing maintenance on a vehicle begins at a step 609 in which a maintenance technician, e.g., an individual who is tasked with ensuring that any appropriate actions are taken with respect to the vehicle, approaches the vehicle which has an HMI through which a status information screen is accessible. The vehicle may be parked at a location such as a depot or maintenance garage. In one embodiment, the status information screen may be arranged to be accessible substantially only when the vehicle is at a secure location such as a depot or a maintenance garage.

In a step 613, the maintenance technician accesses the status information screen on the HMI of the vehicle. The status information may be substantially automatically displayed on the HMI when the vehicle is at a particular location such as a depot. On the other hand, in some instances, the status information may be displayed on the HMI substantially only when the maintenance technician is identified as being authorized to access the status information and/or when there is a confirmation that the vehicle is at a secure location such as a depot. In one embodiment, the maintenance technician may use an application which allows the maintenance technician to gain authorization to the status information at the depot or elsewhere, and the application may use a communications method such as NFC or Bluetooth to effectively instruct the vehicle to cause the HMI to enter depot mode such that status information may be accessed.

Status information may be provided such that the maintenance technician may identify issues to address and/or actions to be taken with respect to the vehicle. For example, error codes which indicate potential problems with the vehicle may be included in the status information. In general, the status information may include diagnostic information which the maintenance technician may utilize to facilitate a determination of appropriate actions to be taken with respect to the vehicle.

The maintenance technician may arrange for appropriate actions to be taken in a step 617 based on the status information. That is, the maintenance technician may perform troubleshooting and/or maintenance to address any issues indicated by the status information.

A determination is made in a step 621 as to whether the maintenance technician has completed actions that are effectively prescribed by the status information. In other words, it is determined whether substantially all, if any, issues indicated in the status information have effectively been resolved. If the determination is that all actions have been completed, then process flow proceeds to an optional step 625 in which the HMI is reset. In one embodiment, the HMI may be reset to a mode associated with vehicle picking up and/or delivering items, or to a default mode, e.g., a mode in which the HMI displays a screen which allows a user to interact with the HMI to seek assistance. Resetting the HMI may include, but is not limited to including, also storing information relating to the current status of the vehicle. The HMI may be reset substantially upon all actions being completed, after a predetermined amount of time has elapsed with no actions or activities detected with respect to the vehicle, at a particular time of the day, or when it is determined that a mission involving the vehicle has been initiated. Upon the HMI being optionally reset, the method of performing maintenance on a vehicle is completed.

Alternatively, if it is determined in step 621 that the maintenance technician has not completed substantially all actions indicated by the status information, the implication is that there are more actions which are to be taken. Accordingly, process flow returns from step 621 to step 617 in which the maintenance technician continues to arrange for appropriate actions to be taken with respect to the vehicle based on the status information.

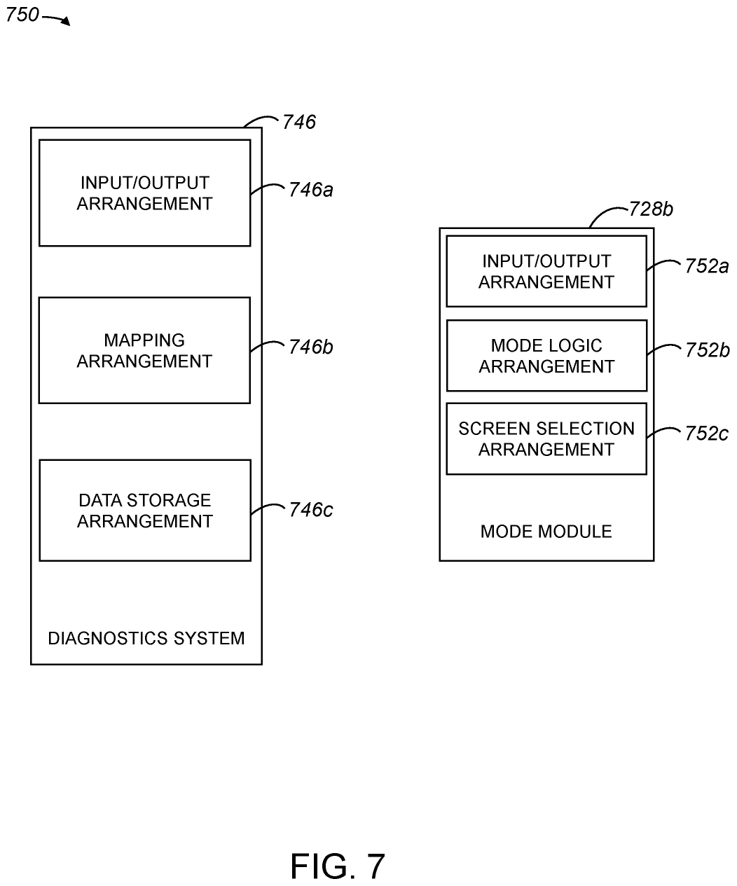

FIG. 7 is a block diagram representation of an overall system which is configured to provide status information and to enable a mode to be selected with respect to an HMI on a vehicle in accordance with an embodiment. An overall system 750 includes a diagnostics system 746 and a mode module 728b. Mode module 728b is generally part of an input/output interface on a vehicle. In one embodiment, diagnostics system 746 is located on a vehicle along with mode module 728b. It should be appreciated, however, that diagnostic system 746 may instead be distributed across an overall network on which a vehicle is considered to be a node, or diagnostic system 726 may not be onboard a vehicle but in communication with the vehicle.

Diagnostics system 746 is generally configured to use information associated with a vehicle to identify issues associated with the vehicle. The information may be processed to determine, for example, the issues that similar information has indicated in the past. Diagnostics system 746 includes an input/output arrangement 746a, a mapping arrangement 746b, and a data storage arrangement 746c, and a resource management arrangement 746d.

Input/output arrangement 746a is configured to obtain information such as an indication of a detected issue, as for example an error code, from a vehicle, and to provide information to the vehicle which indicates one or more actions that the vehicle may take in order for the issues associated with the error code to be substantially resolved.

Mapping arrangement 746b is configured to effectively map an error code to an appropriate response. Mapping arrangement 746b may include logic which effectively processes the error code to determine a suitable response. In one embodiment, mapping arrangement 746b may access information stored in data storage arrangement 746c to facilitate identifying an appropriate response for an error code. An appropriate response to an error code may involve, but is not limited to involving, identifying a type of maintenance which is to be performed on an autonomous vehicle such as autonomous vehicle 101 of FIGS. 2 and 3.

Mode module 728b includes an input/output arrangement 752a, a mode logic arrangement 752b, and a screen selection arrangement 752c. Mode module 728b obtains information from diagnostics system 746, an HMI (not shown), and/or substantially any other component on a vehicle. For example, input/output arrangement 752a may obtain status information such as an error code from diagnostics system 746 and/or an indication of a where the vehicle is currently located from sensors on the vehicle. It should be understood that input/output arrangement 752a may obtain authentication information for a user, e.g., a maintenance technician,

Mode logic arrangement 752b is configured to enable the mode or the state of an HMI on a vehicle to change from one mode to another. By way of example, mode logic arrangement 752b may use data obtained by input/output arrangement 752a to determine whether the vehicle is at a particular location and/or which mode is likely to be associated with the HMI. That is, mode logic arrangement 752b may essentially identify a suitable mode for an HMI based on input received by mode module 728b which may include, but is not limited to including, a current location of the vehicle on which the HMI is mounted, and/or verification or authentication information associated with a user or party attempting to view status information associated with the vehicle. In one embodiment, mode module 728b may obtain information from an application that is associated with authenticating or otherwise verifying that a user has access rights to status information associated with the vehicle.

Screen selection arrangement 752c is arranged to determine, based on the mode logic arrangement, which screen configuration is to be associated with the HMI. In other words, screen selection arrangement 752c identifies an appropriate screen to display based on the mode selected by mode logic arrangement 752b.

In addition to displaying particular information on an HMI of a vehicle substantially only when the vehicle is located at a depot or within a particular zone around the depot, information substantially specific to the current location at which the vehicle is located may generally be displayed on the HMI at the current location. That is, an HMI of a vehicle may display specific information or specific types of information depending on where the vehicle is geographically located. As discussed above, when the vehicle is at a depot or maintenance location, an HMI of the vehicle may display information appropriate for use by a maintenance technician, whereas when the vehicle is not at the depot, the vehicle may display information associated with a delivery or service. In general, when a vehicle is at a location associated with a customer, e.g., at a delivery location or a location at which service is to be provided, an HMI of the vehicle may display information that is associated with the delivery or the service.

It should be appreciated that instead being configurable in approximately two modes, an HMI of a vehicle may have more than two modes or configurations. For example, in addition to having a depot mode and a mode associated with a delivery or service, when a vehicle is not at a depot and not at a location associated with a customer, an HMI of the vehicle may display information which effectively indicates that the vehicle is in transit or the HMI of the vehicle may effectively be turned off or substantially prevented from supporting interactions with the vehicle through the HMI. In other words, an HMI of a vehicle may be in a depot mode when the vehicle is at a depot, in a delivery mode when the vehicle is at a delivery location, and an intermediate mode when the vehicle is neither at the depot nor at the delivery location.

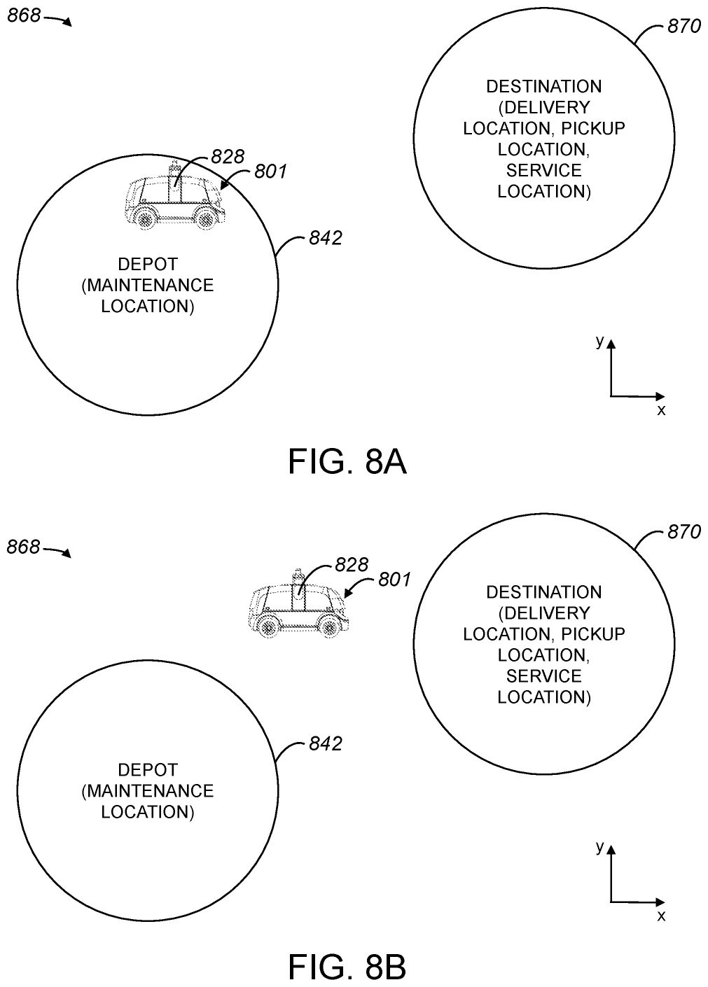

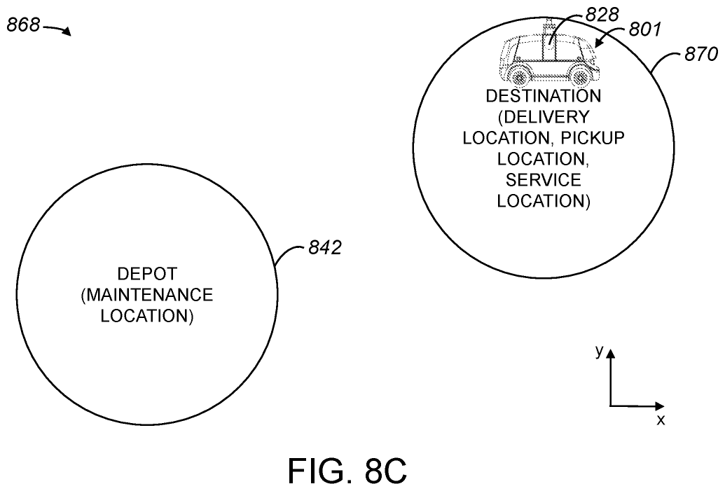

An overall environment within which a vehicle operates may generally include a depot or maintenance zone, a destination, and an intermediate area. FIG. 8A is a diagrammatic representation of a vehicle located in a depot zone of an overall environment in accordance with an embodiment. An overall environment 868 includes a depot or maintenance location 842, and a destination 870. Destination 870 many be any suitable destination or location to which a vehicle 801 that has an HMI 828 may travel as part of completing a task. By way of example, destination 870 may be, but is not limited to being, a delivery location, a goods or passenger pickup location, and/or a service location. Within overall environment 868, substantially any area that is not depot 842 or destination 870 may be considered to be an intermediate area or zone.

In one embodiment, depot 842 may include a physical location of a depot or maintenance location in addition to a zone around the physical location of the depot. Similarly, destination 870 may include, in one embodiment, an actual physical location defined as a destination for vehicle 801 as well as a zone around the actual physical location. For example, an actual physical street address, and an area around the physical street address, may be substantially defined as destination 870.

As shown, vehicle 801 is located within depot 842. When vehicle 801 is located at depot 842, HMI 828 is in a mode in which status information such as maintenance information may be displayed or otherwise accessed using HMI 828. In general, substantially any user at depot 842 may access status information via HMI 828. It should be appreciated that in some instances, a user at depot 842 may be authenticated before allowing the user to access status information using HMI 828. For example, a user such as a technician may engage in an authentication at the process with vehicle 101, and may be confirmed as having authorization or permission to access the status information before the status information is provided to the user on HMI 828. When HMI 828 is in a mode which allows status information such as maintenance information to be displayed, a user with appropriate permissions to access the status information may view or otherwise access the displayed status information.

HMI 828 may substantially automatically enter into a depot mode, or a mode associated with HMI 828 when vehicle 801 is located within depot 842, when vehicle 801 enters into a zone associated with depot 842. In other words, a mode module of vehicle 801, e.g., mode module 728b of FIG. 7, may use sensors on vehicle 801 to detect or otherwise determine when vehicle 801 enters into depot 842, and may set a depot mode such that maintenance information may be displayed on HMI 828. Similarly, a mode module may use sensors on vehicle 801 to detect or otherwise determine when vehicle 801 leaves depot 842, and effectively disengage depot mode. It should be understood, however, that a technician may cause HMI 828 to reset itself upon completion of any desired maintenance on vehicle 801 at depot 842. In the described embodiment, when HMI 828 is reset, HMI 828 may enter into an intermediate mode.

FIG. 8B shows overall environment 868 when vehicle 801 is located in an intermediate zone in accordance with an embodiment. When vehicle 801 is located in an intermediate zone, e.g., not at depot 842 or at destination 870, HMI 828 may be configured in a mode that does not enable maintenance information to be accessed and also does not allow a customer to utilize or interact with HMI 828. For example, HMI 828 may be in an intermediate mode which does not have a user interface that may be used to interact with HMI 828. By configuring HMI 828 in a mode which does not allow for interactions while vehicle 801 is in an intermediate zone, the safety with which vehicle 801 may operate is enhanced as HMI 828 may then substantially only be used when vehicle 801 is at a relatively safe location such as depot 842 or destination 870. For example, a bad actor may be unable to tamper with vehicle 801 using HMI 828 while vehicle 801 is driving in an intermediate zone if he or she is unable to interact with vehicle 801 using HMI 828.

Referring next to FIG. 8C, the presence of vehicle 801 within or at destination 870 will be described in accordance with an embodiment. When vehicle arrives at destination 870, HMI 828 may be substantially automatically configured in a delivery mode. When HMI 828 is in the delivery mode, a user such as a recipient of delivered goods or a service may be presented with a user interface on HMI 828 which allow the user to interact with vehicle 801 using HMI 828. The interaction between the user and vehicle 801 may allow the user to authenticate himself or herself and/or to open one or more compartments on vehicle 801. In one embodiment, HMI 828 remains in the delivery mode until vehicle 801 is determined or otherwise detected as no longer at destination 870, at which time HMI 828 may substantially automatically switch to an intermediate mode.

When a vehicle is at a depot or maintenance location, the vehicle may be powered down, e.g., powered off or powered down to a low power state, until such time as the vehicle is to be assigned another task or mission to perform. To prepare the vehicle to embark on a task or mission, a user may interact with the vehicle using an HMI included on the vehicle to essential place the vehicle into a “mission ready” state. The interactions may involve the user using the HMI to identify procedures to complete, and potential issues to address, before the vehicle is in a mission ready state, or otherwise ready to be deployed. In other words, using status information and startup information which are accessible through the HMI of the vehicle, a user may perform startup procedures and engage in troubleshooting as needed.

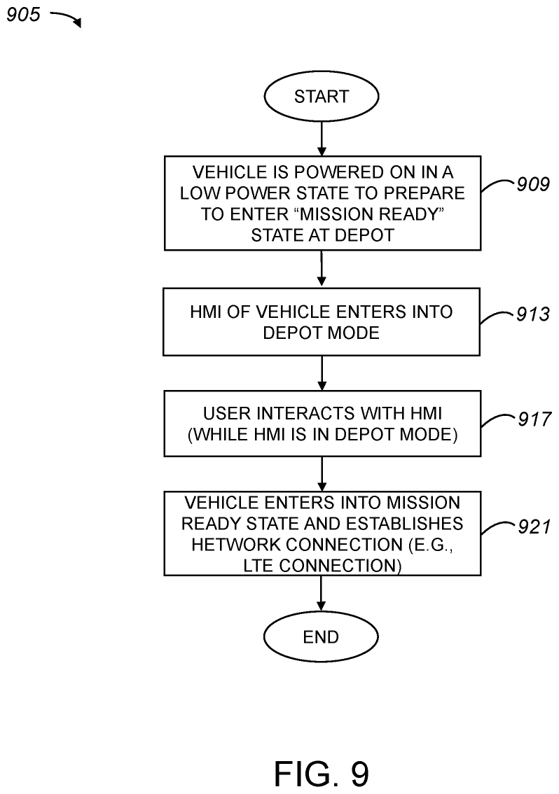

FIG. 9 is a process flow diagram which illustrates a method of using an HMI of a vehicle set in a depot mode to achieve a mission ready state or status for the vehicle in accordance with an embodiment. A method 905 of using an HMI of a vehicle to facilitate causing the vehicle to be placed into a mission ready state begins at a step 909 in which the vehicle is powered on in a relatively low power state in preparation of entering a mission ready state. In the described embodiment, the vehicle is located at a depot. As such, after the vehicle is powered on in a lower power state, the HMI enters into depot mode. It should be appreciated that if the vehicle is not located at a depot when the vehicle is powered on in the lower power state, a user may interact with the HMI to authenticate the user before the vehicle enters into depot mode.

In a step 917, a user interacts with the HMI while the HMI is in depot mode. The user may interact with the HMI as part of a start-up process. Through interacting with the HMI, the user may obtain status information associated with the vehicle, and obtain indications of which procedures the user is to complete before the HMI is essentially ready to be deployed. In one embodiment, the user may use the HMI to log information associated with a start-up process, e.g., to effectively provide an indication of whether diagnostic tests are passed or failed.

Once the user interacts with the HMI, the vehicle enters into the mission ready state, and establishes a network connection in a step 921. The network connection may be any suitable network connection, as for example an LTE connection. The method of using an HMI of a vehicle to facilitate causing the vehicle to be placed into a mission ready state is completed upon the vehicle entering into the mission ready state.

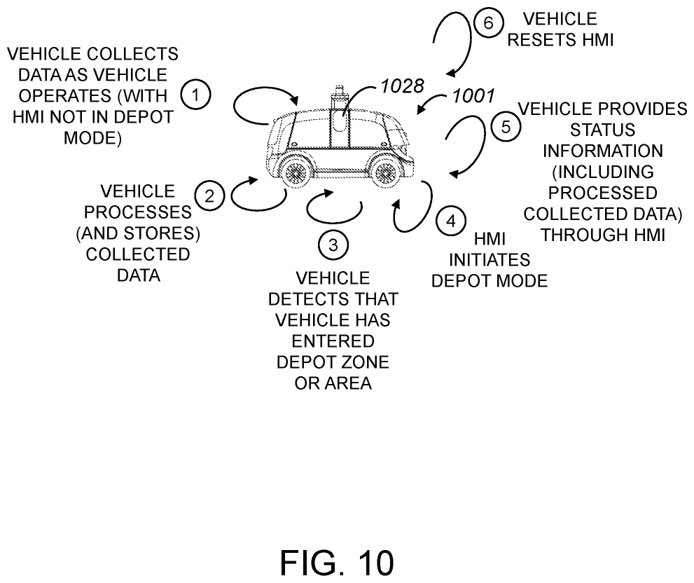

Referring next to FIG. 10, a timeline associated with obtaining and providing status information associated with a vehicle when the vehicle enters into a depot zone will be described in accordance with an embodiment. At a time t1, a vehicle 1001 that includes an HMI 1028 which may be configured in multiple modes including a depot mode collects data as vehicle 1001 operates. As vehicle 1001 operates, HMI 1028 is not in depot mode. The operation of vehicle 1001 may include, but is not limited to including, vehicle 1001 driving to complete a task, or may involve vehicle 1001 being powered up but not driving. Vehicle 1001 may collect data using sensors on vehicle 1001. The collected data may include, but is not limited to including, data associated with the state of systems onboard vehicle 1001 and/or data which indicates the condition of components such as sensors onboard vehicle 1001.

In the described embodiment, vehicle 1001 processes the collected data at a time t2. It should be appreciated that vehicle 1001 may store both the collected data and the processed data. Vehicle 1001 may process the collected data by comparing the collected data to historical data and/or benchmark data to essentially ascertain whether the collected data is consistent with expectations, or whether the collected data indicates a potential issue. In other words, vehicle 1001 may process the collected data to determine whether the collected data indicates a potential issue with vehicle 1001 which may need to be addressed, e.g., by performing troubleshooting and/or maintenance on vehicle 1001. Processing the collected data may also include, but is not limited to including, mapping the processed data to an error code which identifies a type of issue or error associated with the processed data.

At a time t3, vehicle 1001 detects that vehicle 1001 has entered a depot or maintenance zone. Vehicle 1001 may use onboard sensors, e.g., a GPS sensor, to determine when vehicle 1001 is located at a depot. That is, vehicle 1001 may use sensors to determine when vehicle 1001 has arrived at a destination that includes a depot or an area which enables diagnostics to be tested, designed, and implemented.

After vehicle 1001 has entered a depot zone, HMI 1028 initiates a depot mode at a time t4. In one embodiment, HMI 1028 may substantially automatically initiate the depot mode such that status information may be accessible using HMI 1028. In another embodiment, HMI 1028 may effectively initiate the depot mode after a user who will use HMI 1028 to access status information is authenticated.

Once depot mode is initiated, vehicle 1001 provides status information, including processed data, through HMI 1028 at a time t5. Providing the status information may include, but is not limited to including, displaying the status information on HMI 1028 and/or displaying one or more error codes which identify potential issues with vehicle 1001 on HMI 1028. The status information may substantially automatically be rendered on a display screen associated with HMI 1028, or the status information may be rendered upon a user interacting with HMI 1028 to effectively request the status information.

At a time t6, after the status information is used by a user to identify maintenance and/or troubleshooting tasks to complete, vehicle 1001 may be ready to be deployed on a mission. That is, upon successful completion of maintenance and troubleshooting tasks, vehicle 1001 is prepared to be deployed. As such, HMI 1028 may be reset by vehicle 1001, upon an indication being provided by a user, to indicate that any issues identified in the status information have been addressed. In one embodiment, HMI 1028 may remain in depot mode until vehicle 1001 departs the depot zone, although it should be appreciated that resetting HMI 1028 may involve placing HMI 1028 into a different mode, e.g., an intermediate mode or an operational mode.

As previously mentioned, depot mode may be initiated for an HMI on a vehicle upon authenticating a user, even when the vehicle is not at a depot or other location in which depot mode is substantially automatically activated. Further, in some embodiments, even when a vehicle is at a depot, the HMI of the vehicle may be arranged to enter into depot mode when a user is authenticated, and not substantially automatically upon the vehicle being detected at the depot. In other words, in one embodiment, a user may effectively need to participate in an authentication process to access depot mode on an HMI of a vehicle, regardless of where the vehicle is located.

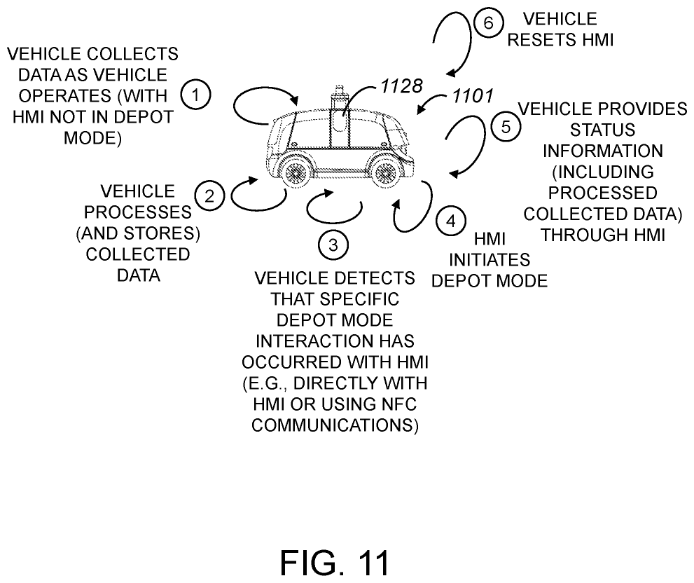

FIG. 11 is a diagrammatic representation of a timeline associated with obtaining and providing status information associated with a vehicle when the vehicle detects an interaction which indicates depot zone is activated in accordance with an embodiment. At a time t1, a vehicle 1101 that includes an HMI 1128 which may be configured in a depot mode collects data as vehicle 1101 operates. While vehicle 1001 operates, HMI 1128 is generally in an operational mode or an intermediate mode. Vehicle 1101 may collect data using sensors onboard vehicle 1101. The collected data may include, but is not limited to including, data associated with the state of systems onboard vehicle 1101 and/or data which indicates the condition of components such as sensors onboard vehicle 1101.

At a time t2, vehicle 1101 processes the collected data. It should be appreciated that vehicle 1101 may store both the collected data and the processed data. The collected data and the processed data may be stored onboard vehicle 1101 or offboard with respect to vehicle 1101.

At a time t3, vehicle 1101 detects that specific input associated with a request to place HMI 1128 in a depot mode has been detected with respect to HMI 1128. The specific input may generally be an input to a home screen of HMI 1128 that effectively causes HMI 1128 to enter into a depot mode. The input may be an access code, but is not limited to being an access code. For instance, the input may involve performing an action with respect to HMI 1128, e.g., the input may be a number of taps at a particular location or area of HMI 1128. The input may also be communications between a device in the possession of a user and HMI 1128, e.g., communications that use NFC.

After vehicle 1101 detects a specific interaction that is an indication of a request to place HMI 1128 into a depot mode, HMI 1128 initiates a depot mode at a time t4. Once depot mode is initiated, vehicle 1101 provides status information, including processed data, through HMI 1128 at a time t5.

At a time t6, after the status information is used by a user to identify maintenance and/or troubleshooting tasks to complete, vehicle 1101 may be ready to be deployed on a mission. Accordingly, HMI 1128 may be reset by vehicle 1101, upon an indication being provided by a user, to indicate that any issues identified in the status information have been addressed.

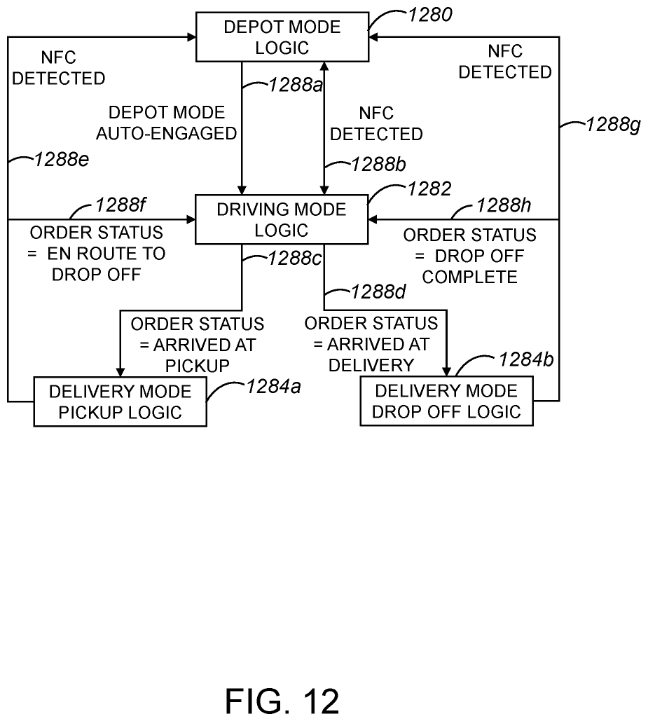

As previously mentioned, an HMI on a vehicle may be associated with multiple modes, including a mode which substantially prevents the HMI from being used to interface with the vehicle while the HMI is in transit, e.g., driving to a delivery location or a pickup location. The mode that the HMI is set to may vary depending upon the particular situation the vehicle is in, or in which state the vehicle is in. With reference to FIG. 12, various HMI modes will be described in accordance with an embodiment. A mode logic arrangement such as mode logic arrangement 752b of FIG. 7 includes depot mode logic 1280, driving mode logic 1282, delivery mode pickup logic 1284a, and delivery mode drop-off logic 1284b. Depot mode logic 1280 enables an HMI of a vehicle to operate in depot mode. Driving mode logic 1282, in one embodiment, effectively either disables the HMI from supporting user interactions or turns off the HMI while the vehicle is driving or in transit. Delivery mode pickup logic 1284a enables the HMI to be used by a user at a pickup location to enable the vehicle to pick up an item. Delivery mode drop-off logic 1284b enables the HMI to be used by a user at a drop off location to enable the vehicle to drop off an item. It should be appreciated that in some situations, delivery mode pickup logic 1284a and delivery mode drop off logic 1284b may be substantially the same.

Depot mode logic 1280 may be substantially automatically engaged, or auto-engaged, as shown at 1288a when a vehicle is located at a depot or other trusted location. Depot mode logic 1280 may also be engaged when NFC communications are detected, e.g., from a device that communicates with the vehicle, as shown at 1288b.

The disengagement of depot mode may occur when the vehicle is determined to be ready or otherwise prepared to be drive. That is, driving mode logic 1282 may be engaged either when depot mode is substantially automatically disengaged from depot mode or when NFC communications are no longer detected. Driving mode logic 1282 may be engaged until it is determined that the vehicle has arrived at a depot, when NFC is detected, when an order status indicates arrival of the vehicle at a pickup location as shown at 1288c, or when an order status indicates arrival of the vehicle at a delivery or drop off location as shown at 1288d. The order status may be substantially updated based on a location of the vehicle, e.g., an order status may be updated to indicate that the vehicle has arrived at a pickup or drop off location when sensors which track the location of the vehicle indicate arrival at the pickup or drop off location. When the order status indicates that the vehicle has arrived at a pickup location, delivery mode pickup logic 1284a is activated or engaged. When the order status indicates that the vehicle has arrived at a drop off or delivery location, delivery mode drop off logic 1284 is activated or engaged.

When delivery mode pickup logic 1284a is engaged, the engagement may remain until the pickup process is completed. Once the pickup process is completed, if NFC communications are detected as shown at 1288e, depot mode logic 1280 is engaged or activated. Alternatively, if the order status indicates that the vehicle is en route to or otherwise in transit to a drop of location as shown at 1288f, then driving mode logic 1282 is engaged or activated.

When delivery mode drop off logic 1284 is engaged, the engagement may remain until a drop off process is completed. When the drop off process is completed, if NFC communications are detected as shown at 1288g, depot mode logic 1280 is engaged or activated. On the other hand, if the order status indicates that the drop off is complete, then driving mode logic 1282 is engaged or activated. For example, driving mode logic 1282 may be engaged as the vehicle awaits instructions for where to drive next, or as the vehicle drives to a depot or other location.

Although only a few embodiments have been described in this disclosure, it should be understood that the disclosure may be embodied in many other specific forms without departing from the spirit or the scope of the present disclosure. By way of example, while an HMI has generally been described as having an operational mode, or mode of display, associated with a depot and another operational mode otherwise. There may be various operational modes and, hence, modes of display associated with an HMI. In one embodiment, an HMI on a vehicle may have a mode which enables a customer to interact with the vehicle when the vehicle is on a delivery or pick up mission, a mode which is a substantially default mode which enables an individual request assistance, and a mode which enables status information to be displayed upon authentication a user as having appropriate access rights to the status information.

The information provided on a screen of an HMI that enables a maintenance technician to troubleshoot and/or to attempt to resolve issues may vary. While the use of error codes to effectively provide status information relating to a potential issue, e.g., a fault or a failure, it should be appreciated that status information may be provided in any suitable manner. For instance, substantially raw status information may be provided such that a maintenance technician may view the status information on an HMI when a vehicle is at a particular location such as depot. Such a maintenance technician may decimate the status information to identify issues that the vehicle is subject to.

An HMI mounted on or in a vehicle has been described as including a touchscreen display on which status information relating to the vehicle may be displayed when the HMI is in a depot mode. An HMI, however, is not limited to including a touchscreen display. Suitable HMIs may include, but are not limited to including, displays, cameras, speakers, and/or microphones. When an HMI includes a speaker, rendering status information or other diagnostic information such that a user may receive the information may involve providing the status information as an audio signal.

While a maintenance technician has generally been described as a user who may obtain status information from an HMI of a vehicle when the HMI is in depot mode, it should be appreciated that users of an HMI operating in depot mode are not limited to being maintenance technicians. In addition, maintenance technicians may include, but are not limited to including, fleet support specialists, fleet technicians, closed course operators, fleet engineers, and/or other technicians. Fleet support specialists may be responsible for cleaning vehicles, charging and/or fueling vehicles, and other tasks which effectively sustain vehicles. Fleet technicians may perform service tasks related to vehicles including, but not limited to including, performing repairs relating to hardware and/or software. Closed course operators may conduct operations and tests of vehicles on closed courses. Fleet engineers may perform tasks that are escalated by fleet support specialists and fleet technicians.

In one embodiment, an HMI or an autonomous vehicle may include a home screen which may solicit input from a user, e.g., a customer or a maintenance technician, when the autonomous vehicle is not located at a depot or a known maintenance location. Upon obtaining input from the user, the HMI may proceed to either display a screen that is suitable for use by a customer or display a screen which enables a maintenance technician to provide authentication information.

A depot has generally been described as a maintenance location, or a location at which maintenance may be performed on a vehicle. It should be appreciated that a maintenance location is not limited to being a depot. In addition to being a depot, a maintenance location may be, but is not limited to being, a yard, a garage, a workshop, a maintenance yard, a storehouse, a warehouse, and/or a parking lot.

While an HMI of a vehicle has been described as having modes that include a depot mode, an operational or customer mode, and/or an intermediate mode, the HMI of a vehicle is not limited to having a depot mode an operational mode, and/or an intermediate mode. By way of example, an HMI of a vehicle may have modes specific to particular users, modes specific to particular operations, and/or modes specific to particular situations. Modes specific to particular operations may include, but are not limited to including, a delivery mode and a pickup mode. Modes specific to particular situations may include, but are not limited to including, an emergency services mode and a diagnostics mode. The emergency services mode may enable an emergency services provider to use an HMI on a vehicle to communicate with a teleoperations monitor arrangement or a party associated with an enterprise that manages the vehicle. A diagnostics mode may, in one embodiment, provide granular diagnostic information which may be used by technicians to trouble shoot the vehicle. A diagnostics mode may differ from a depot mode, for example, because the depot mode may provide information used by service specialists to start, shutdown, and rescue a vehicle while a diagnostics mode may provide information used to diagnose any issues with the vehicle. It should be understood, however, that in some embodiments, depot mode may provide information which may be used to trouble shoot a vehicle and to identify issues associated with the vehicle. In other words, depot mode may encompass a diagnostics mode in some embodiments.

When an HMI of a vehicle enters into a depot mode, it should be appreciated that other states of the vehicle may also effectively enter into depot mode. That is, depot mode may have configurations for the vehicle that are not limited to a configuration for an HMI. By way of example, when a vehicle enters into a depot mode, the power state of the vehicle may be adjusted to a low power state, doors of the vehicle may be unlocked and/or opened, access to a charging port of the vehicle may be provided, and/or headlights or hazard lights of the vehicle may be turned off. In one embodiment, when a vehicle enters into a depot mode, a remote control may be substantially paired to the vehicle.

In one embodiment, one or more modes of an HMI on a vehicle may be interactive. For example, a depot mode or other mode may include a capability to enable a user to verbally interact with an HMI such that the user may request information verbally, and the HMI may respond audibly and/or visually. That is, a user may audibly query an HMI, and the HMI may provide an audible and/or visual response.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner. The autonomous vehicle may also either be arranged to carry goods, passengers, and/or both goods and passengers.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
determining when a vehicle is in a location that is suitable for providing status information associated with the vehicle on a human machine interface (HMI) of the vehicle, the vehicle including an autonomy system arranged to enable the vehicle to operate autonomously, a diagnostics system, a mode module, and the HMI, the HMI being arranged to provide a user interface which allows interactions with the vehicle;
determining the status information for the vehicle using the diagnostics system when it is determined that the vehicle is in the location that is suitable for providing the status information associated with the vehicle on the HMI;
setting the HMI to a first mode using the mode module when it is determined that the vehicle is located in the location that is suitable for providing the status information associated with the vehicle on the HMI;
causing the status information to be provided to the mode module after determining the status information and setting the HMI to the first mode; and
providing the status information to the HMI, wherein the HMI is further arranged to display the status information.

2. The method of claim 1 wherein determining when the vehicle is in the location that is suitable for providing the status information associated with the vehicle on the HMI includes:
determining when the vehicle is located within a first area using the mode module.

3. The method of claim 2 further including:
determining when the status information indicates at least a first issue with the vehicle;
determining when the at least first issue is resolved; and
setting the HMI to a second mode when it is determined that the at least first issue is resolved, wherein when the HMI is in the second mode, the status information is not provided to the HMI.

4. The method of claim 3 wherein the vehicle includes at least one compartment, and wherein the second mode enables a first user to use the HMI to access the at least one compartment.

5. The method of claim 1 wherein determining when the vehicle is in the location that is suitable for providing the status information associated with the vehicle on the HMI includes:
authenticating a first user associated with the location, wherein authenticating the first user includes determining whether the first user is authorized to obtain the status information, wherein the status information is provided to the HMI when it is determined that the first user is authorized to obtain the status information.

6. The method of claim 1 wherein the status information includes vehicle maintenance information.

7. Logic encoded in one or more tangible non-transitory, computer-readable media for execution and when executed operable to:
provide an autonomy system on a vehicle;
provide a diagnostics system on the vehicle;
provide a human machine interface (HMI) on the vehicle, the HMI being arranged to provide a user interface which allows interactions with the vehicle;
enable a mode selection for the HMI;
determine when the vehicle is in a location that is suitable for providing status information associated with the vehicle on the HMI;
determine the status information for the vehicle using the diagnostics system when it is determined that the vehicle is in the location that is suitable for providing the status information associated with the vehicle on the HMI;
set the HMI to a first mode using the mode module when it is determined that the vehicle is located in the location that is suitable for providing the status information associated with the vehicle on the HMI;
cause the status information to be provided to the mode module after the status information is determined and after the HMI is set to the first mode; and
provide the status information to the HMI, wherein the HMI is further arranged to display the status information.

8. The logic of claim 7 wherein the logic operable to determine when the vehicle is in the location that is suitable for providing the status information associated with the vehicle on the HMI is further operable to determine when the vehicle is located within a first area.

9. The logic of claim 8 further operable to:
determine when the status information indicates at least a first issue with the vehicle;
determine when the at least first issue is resolved; and
set the HMI to a second mode when it is determined that the at least first issue is resolved, wherein when the HMI is in the second mode, the status information is not provided to the HMI.

10. The logic of claim 9 wherein the vehicle includes at least one compartment, and wherein the second mode enables a first user to use the HMI to access the at least one compartment.

11. The logic of claim 7 wherein the logic operable to determine when the vehicle is in the location that is suitable for the status information associated with the vehicle to be provided on the HMI is further operable to:
authenticate a first user associated with the location, wherein the logic operable to authenticate the first user includes logic operable to determine whether the first user is authorized to obtain the status information, wherein the status information is provided to the HMI when it is determined that the first user is authorized to obtain the status information.

12. The logic of claim 7 wherein the status information includes vehicle maintenance information.

13. A vehicle comprising:
an autonomy system, the autonomy system arranged to enable the vehicle to operate autonomously, the autonomy system including a set of sensors;
a diagnostics system, the diagnostics system configured to obtain status information associated with the vehicle from at least the set of sensors; and
a first input/output arrangement, the first input/output arrangement including a mode module and a human machine interface (HMI), the HMI being arranged to provide a user interface which allows interactions with the vehicle when set in a second mode by the mode module, the first input/output arrangement arranged to obtain the status information from the diagnostics system, wherein the mode module is arranged to identify one selected from a group including a location of the vehicle using the set of sensors and a sequence provided to the HMI which indicates that the HMI is to be set in a second mode, the mode module further being arranged to determine when the location is suitable to enable the status information to be accessed through the HMI, and wherein when the mode module determines that the location is suitable to enable the status information to be accessed through the HMI, the mode module sets the first mode for the HMI and provides the status information to the HMI.

14. The vehicle of claim 13 wherein the mode module is arranged to reset the HMI to the second mode when a first task identified in the status information is completed, wherein when the HMI is set to the second mode, the status information is not accessible through the HMI.

15. The vehicle of claim 13 further including:
at least one compartment, wherein when the HMI is set to the second mode, HMI is used to enable access to the at least one compartment.

16. The vehicle of claim 13 wherein the first input/output arrangement is configured to authenticate a user when the mode module determines that the location is suitable to enable the status information to be accessed through the HMI, and wherein the module module provides the status information to the HMI after the user is authenticated.

17. The vehicle of claim 13 wherein the status information includes vehicle maintenance information.

18. The vehicle of claim 13 further including:
a body, wherein the HMI is mounted to an exterior of the body.

19. The vehicle of claim 13 wherein the diagnostics system includes a second input/output arrangement, and wherein when the status information includes a first maintenance issue, the diagnostics system is arranged to obtain an error code for the first maintenance issue from the second input/output arrangement and to provide the error code to the HMI when the HMI is set to the first mode.

20. The vehicle of claim 19 wherein the diagnostics system further includes a mapping arrangement, the mapping arrangement being arranged to map the error code to a response to the first maintenance issue.
